(19) United States
(12) Patent Application Publication
(10) Pub. No.: US 2007/0100644 A1
(43) Pub. Date: May 3, 2007

(54) Consumer-initiated marketing for real-estate connected products

(76) Inventors: R. David Keillor, Rochester, MN (US); Thomas G. Ress, Byron, MN (US); Timothy Walsh, Rochester, MN (US); James Matteson, Rochester, MN (US); Lian Yu, Rochester, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/259,949

(22) Filed: Oct. 27, 2005

(51) Int. Cl. G06Q 99/00

(52) U.S. Cl. 705/1

(57) ABSTRACT

A website for marketing real estate or products relating to real estate includes personal webspaces for users. Assigned user roles determine which capabilities they may configure into their webspaces. Users may communicate with each other and with merchants, e.g., by sharing webspaces or by dialogs. Merchants may send product information only certain users in response to users' expressed or inferred desires. Collected product and user data may be used to calculate propensities of individual users, marketability of individual products, or market trends.

### TECHNICAL FIELD

The subject matter concerns computer-based systems and software useful for marketing of goods and services in connection with real estate.

### BACKGROUND

Parcels of real estate constitute a huge market in and of themselves. A number of computer-based systems to aid real-estate brokers such as Realtors®, and other businesses in listing real-estate parcels and prospective buyers. Such systems commonly incorporate databases searchable for particular types of parcels or other data narrowly focused upon the specific market of buying and selling the real estate itself. That is, these systems have not viewed the real-estate market as embracing other goods and services that a prospective consumer might desire in connection with buying or selling a residence or commercial property.

Furthermore, conventional marketing systems use “push” techniques. Although merchants may target specific classes of prospective consumers, the consumers themselves have no direct involvement with suppliers' decisions to send advertisements, promotions, or other materials to them, unless the prospects themselves request further information on specific products that they may have already seen advertised in a push environment. On-line searches may furnish some answers, but may take time and may generate many irrelevant results. Further, such searches may provide consumers with little by which to judge suppliers' quality or appropriateness to their needs.

### SUMMARY

The real estate market differs from that for other items, even big-ticket goods such as automobiles, in a number of ways. No two parcels are alike. Consumers (both buyers and sellers) commonly make use of brokers, and may spend months or even years on a single transaction. (Although this description will use residential real estate as an example, commercial and industrial real estate are similar in most relevant ways.)

One little-appreciated aspect of real estate is that buyers and sellers of properties almost invariably spend a significant amount of the purchase price of a property for other goods and services connected with the property and to the process of buying or selling it. A survey has shown that buyers of new residences spend 7% of the purchase price on repairing or remodeling their new homes within a year of purchase. Home sellers also typically spend significant amounts on preparing their residences for sale.

The present invention offers a computer-based system for marketing real estate and connected goods or services in a manner that is simple and attractive for consumers, including both current and prospective buyers and sellers. It employs a “pull” model that is directed by consumers rather than by suppliers. A web-based entity includes personal web spaces accessed by a user gateway that flows through a sponsor website. Users are assigned different roles or classes to determine which facilities of the website they may employ. A database tracks users' interests, and matches them with products (goods and services) from merchants who are affiliated with the website. In this way, the users may receive what they want, rather than what the merchants might think that they want, without annoying advertising gimmicks or spam. Data from users may also be aggregated and manipulated to produce measures beneficial for marketing purposes.

The invention provides an engaging web experience in the form of a website having “personal webspaces” that entice consumers to return frequently on a long-term basis by compelling content and wide-ranging capabilities that can be dynamically configured to different roles, and individual preferences that can be both directly expressed and inferred. The invention goes beyond demographic and other methods of targeted marketing to a “pull” model that allows consumers to collaborate in managing the marketing of products to them. Consumers may specify their own desires, both expressly and more generally as to types of products. In addition, algorithms may employ data available to the website to infer and accommodate other desires for products. Such algorithms may employ aggregated data from all consumers. Adaptive methods may retain consumers over long periods of time by addressing changes in their roles or desires.

Besides connecting people to information, websites according to the invention may connect people to each other. by dialogs among users themselves or between users and merchants, or by sharing their personal webspaces with each other or with merchants.

### BRIEF DESCRIPTION OF THE DRAWINGS

FIG. 1 is a high-level block diagram of an overall system.

FIG. 2 is a symbolic representation of a personal webspace for a specific user.

FIG. 3 is a flowchart of a method for performing user functions from a personal webspace.

FIG. 4 is a flowchart of a method for matching user desires to product offerings.

FIG. 5 is a flowchart of a method for performing merchant functions in a sponsored website.

FIG. 6 is a flowchart of a method for generating prospective-buyer indices.

FIG. 7 is a flowchart of a method for generating current market indices.

### DESCRIPTION

### Definitions

The following defines certain terms used throughout the description.
Real-estate transaction: An activity such as a purchase, sale, or lease of a parcel of real-estate. The transaction may be prospective, ongoing, or completed.
Consumer: A person who may desire to purchase products in connection with a real-estate transaction, including prospective and actual buyers, sellers, lessors, lessees, etc., of real-estate.
User: A person who is registered at a sponsored website to obtain information or services. Users may include consumers, real-estate agents or brokers, or any other participants in transactions, such as appraisers, inspectors, and mortgage providers. Users may include merchants and suppliers of related products, such as remodeling products. The sponsor decides who may or may not be a user.
Role: One of a number of defined classes of users.
Invitee: Users may authorize other persons, users or non-users, access to some or all areas or facilities of their personal webspaces.
Visitor: A person who may wish to obtain information from a sponsored website, but who is not registered as a user.
Product: A good or service that may be offered to consumers in connection with the ownership or use of real estate. Products may include real-estate parcels or properties themselves, products for maintaining or upgrading a properties, their furnishings, or immediate surroundings. Examples may include a wide range such as remodeling materials, furniture, or garden tools, and may further include services such as construction, lawn care, loans, or security. The word “products” may also be used herein as a shorthand for information, listings, promotions, or other materials concerning such goods or services.
Merchant (or affinity merchant): A provider of products who is enrolled on a sponsored website. Merchants may include those who deal directly in real estate, such as agents, brokers, or multiple-listing services, and may further include suppliers of many different kinds of other products connected with the ownership (or leasing, rental, etc.) of real estate. Merchants are normally users with assigned roles, but they need not be.
Agent: A person or organization that acts for a buyer or seller in real-estate transactions. Although real-estate agents and brokers have different legal status, and Realtors® have certain additional qualifications, the term “agent” as used herein may refer to brokers, Realtors®, or others, such as listing services or similar entities.
Sponsor: An entity that hosts a sponsored website. Sponsors may include commercial businesses who may offer branded products themselves, or non-partisan organizations such as multiple-listing services (MLS). The sponsor may be represented by a system administrator.
   Terms such as “purchase” or sale” encompass leases, rentals, licenses, or other transfers of rights in products. Similarly, those engaged in such transfers are referred to an “buyers” or “sellers,” although these terms embrace lessors, lessees, licensors, renters, licensees, or others involved in transferring rights to products, such as agents or mortgagees. Related terms, such as “owner” or “ownership” also pertain to other rights in addition to legal title to property.

### Systems

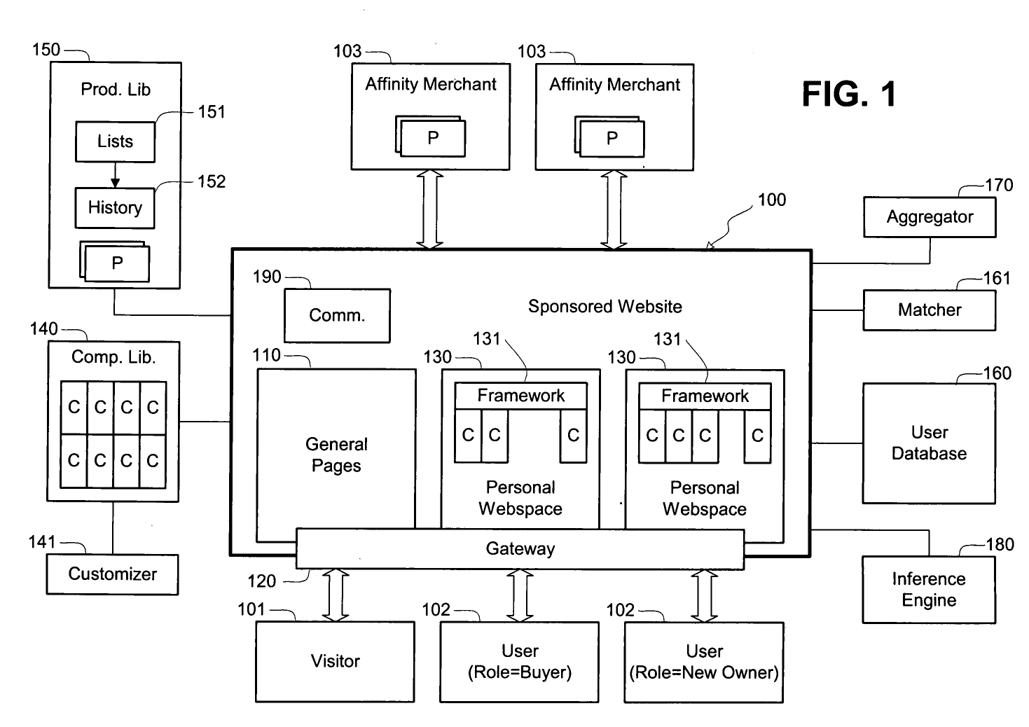

FIG. 1 schematizes an example system 100 for a sponsored website. The blocks in system 100 represent data structures, computer programming, or hardware for implementing their function on one or more servers connected to the web, or on other devices. “Website” herein denotes an addressable site on the World Wide Web or on a similar wide-area public network; any of such networks is designated “the web” herein.

System 100 offers a website that is provided and maintained by a sponsor who my be involved in some phase of the real-estate market. A multiple listing service (MLS) may offer a nonpartisan website, for example. A real-estate agent or firm may host a commercial website. A sponsor need not be involved in real estate directly, although he would of course expect to derive revenue from it in some manner, such as by offering his own or others' branded products to consumers in this market. A sponsor might profit directly from website 100 by charging fees for various ones of its services.

Casual visitors 101 to website 100 may access a home page and other general pages 110 via a gateway 120. Such pages may advertise the website itself, and may provide some services to the general public, such real-estate market news. They may also invite visitors to become registered users. Persons who are already registered as users 102 can log in via the gateway to their own personal webspaces 130 with individual usernames and passwords. Each of these personal webspaces may be customizable by the user as to appearance and capabilities, and may be changed dynamically at any time.

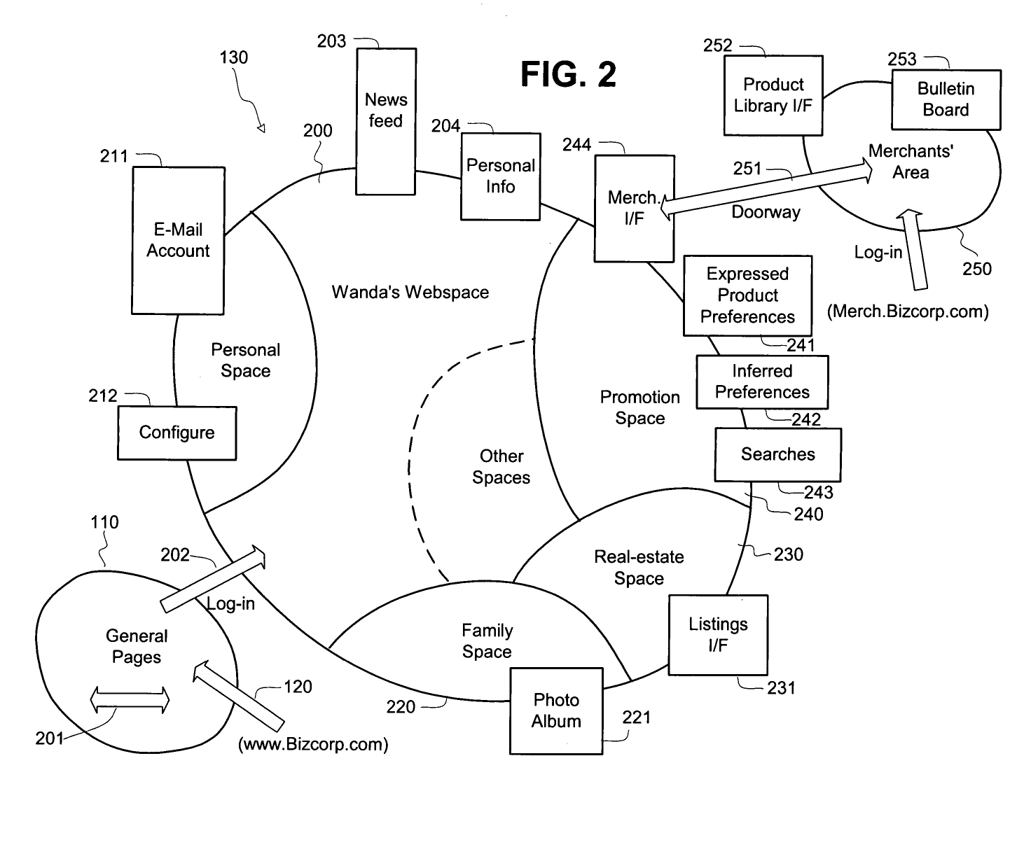

The website provides each personal webspace with a framework 131. A component library 140 stores a number of components C in a library 140 attached to the website. Components include software for performing different functions, such as data searchers, newsfeeds, and e-mail connections. Components may also include appearance items such as skins that users may select to customize the visual style of their webspaces. Users customize their personal webspaces 130 by plugging different numbers and combinations of the components C into a copy of their framework 131, employing a customization facility 141 attached to the website. Not all components are available to all users. Users' roles determine which components they may actually choose to include in their personal webspace 130. Available components may be displayed the users as lists; selected components may be stored in profiles (not shown) stored for the respective users. Roles are described in connection with FIG. 2. Components may be also be selected for users or for visitors at many levels. In addition to users selecting components for themselves, the sponsor, system administrator, or another user may select components for users. For example, an agent may select certain components for his clients. Components selected for others must be available to the role of the selector.

Personal webspaces 130 differ from web portals such as America On-Line® (AOL), Yahoo!®, and eBay®. Conventional portals may register members and allow members, or certain members, to specify which of a number of listed items may appear, to choose some appearance styles from a menu, to store limited amounts of information, or to establish e-mail accounts. However, advertising presented as panels, pop-ups, or e-mail attachments appear to all members, or to those targeted by their originating merchants; the members themselves have no way to invite only certain ones. Personal webspaces differ in the degree and flexibility of sharing, the fine granularity of roles, which need not be hierarchical (so that users may have multiple roles), the way in which content and functions of the webspaces may be dynamically tailored based upon user roles or configurability by the sponsor, administrator, users themselves, or other users. A website such as 100 further offers user-centered information such as product offers, market and user measurements, or historical or predictive market information having value to merchants.

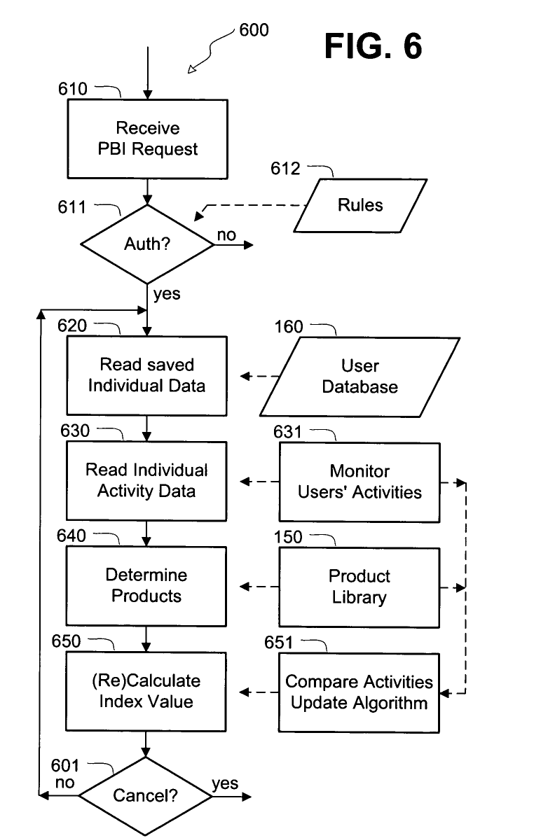

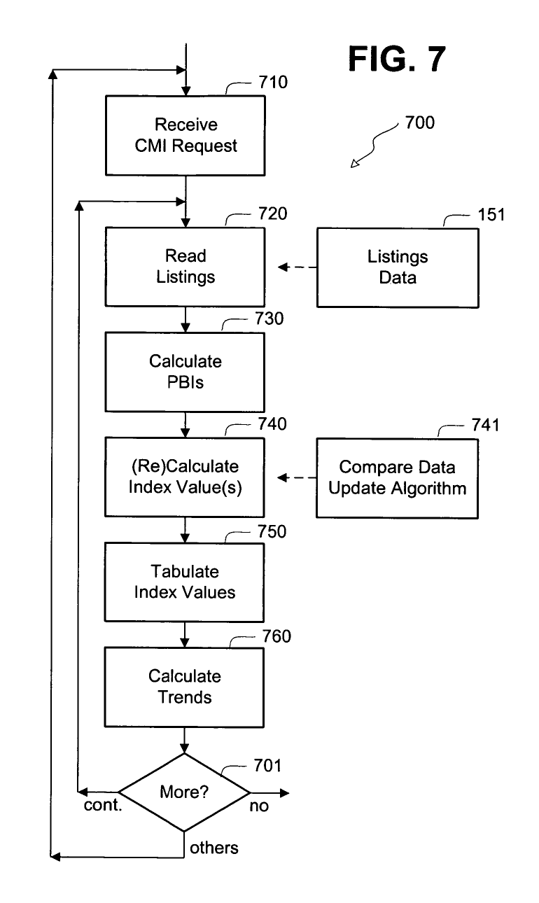

Affinity merchants 103 offering a wide range of products P may participate in website 100 upon invitation by or application to the sponsor. Products P may be represented as web pages, files, or other forms that can be communicated to personal webspaces 130. These may be sent from merchants' websites and stored in a product library 150, or distributed directly to matched users. Library 150 may also contain listings 151 of real-estate parcels currently or previously on the market. Properties in these listing may be obtained from real-estate agents or brokers affiliated with the site, others by agreement, or from public records. Library 150 may include a history database 152 derived dynamically, manually or automatically, from listings 151 and from other sources. This database may include historical data on events such as dates or amounts of price changes, status changes, when placed on the market or sold, of properties in listings 151. Library 150 may be physically stored anywhere that is quickly accessible to website 100. Dynamically updated records of this type of event information that is available very quickly to website 100 permit features such as the derivation of valuable measures for the real-estate market, as described in connection with FIGS. 6 and 7. History database 152 may permit delivery of calculations concerning current real-estate markets in very short times, less than five minutes, and typically less than thirty seconds. Library 150 may further include information, such as profiles, authorizations, or names/passwords of merchants.

A database 160 of user information records information regarding desires of individual users 102 for specific products or product types, and may also retain demographic, location, or other information that individual users may volunteer. Database 160 also saves information that the user may produce, such as the parameters of searches and their results, lists of favorites (evoked sets), or communications with merchants or with other users. Additional data may include history or usage data, such as dates, durations, frequencies, or nature of activity in their personal webspaces. Further data may pertain to the users' specific properties, such as descriptions, current or historical market information, or maintenance records. Other data may include special offers from affinity merchants. Each user has his own area within the database. Matching software 161 may compare users' expressed desires from database 160 to products P and send appropriate products to those users who have requested them, from library 150 or directly from the merchants. Records in library 160 may be linked to records in product library 150; for example, a user may be linked to one or more specific property records in listings 151. Users may be linked to other users or to merchants, as in the case of agents and their clients.

Software 170 may aggregate information from database 150 for a number of purposes, such as how long residences in particular price ranges stay on the market, trends in housing styles, and so forth. Aggregated data may be given or sold to merchants 103 or to others.

Inference software 180 may be attached to website 100 to process information from database 160 and other sources for the purpose of predicting the propensity of individual consumers to buy a specific real estate or products, and to predict the marketability of products or real estate offered on the website. Software 180 may produce data which match software 161 may employ in deciding to send certain products P to specific users 102. That is, software 180 may infer that a user may desire to learn about a product on the basis of the user's expressed desires and other factors.

Communications software 190 implements a number of communications facilities within website 100. It may include threaded dialogs, webspace-sharing, web logs (blogs), bulletin boards, or similar mechanisms for users to communicate with merchants, with the system administrator, and with each other. For example, users 102 may carry on threaded dialogs or discussion with each other or with affinity merchants 103. Users may elect to share all or parts of their own webspaces with other users. Merchants may share portions of certain users' webspaces, either by invitation or by authorization from the sponsor.

FIG. 2 is a conceptual view 200 of an example of a personal webspace 130 for a user named Wanda who is a prospective buyer of a new residence. Her entry to the space is gateway 120, owned by a fictional sponsor Biz Corp. under the URL “www.bizcorp.com.” Everyone using the gateway sees the same look and feel and content at this point. Wanda may then navigate at 201 to other pages (not shown) on the site, or may log into her own space 130 with a username and password at 202. It is this space 130 that she can personalize to her own individual tastes, within the capabilities offered to users in her role of prospective buyer. Wanda may access and create a number of features in her space, using the components C from FIG. 1. For example, she may access a newsfeed 203 from an external source, or she may set up an area 204 containing personal information that she is willing to give out. In general, webspaces or portions may be shared with others. Wanda herself may elect to share with selected other users or merchants. The sponsor may permit merchants automatic rights to share portions of Wanda's space, in exchange for services that they provide to her. For example, Wanda's real-estate agent may have access to her saved searches or favorites.

Wanda's space 130 contains a number of spaces or areas. These spaces may include other features executed by components C. For example she may send and receive mail from her personal space 210 via an e-mail account component 211. Space 210 also contains a configuration facility 212 for personalizing her webspace 130. She may also reconfigure it or apply for role changes. Wanda may create a family space 220 including a photo album 221 or other features. A real-estate space 230 may offer features such as an interface 231 to listings 151 of residences currently available on the market.

Promotion space 240 offers personally targeted marketing. This space implements a “pull’ technique that receives product materials only in response to Wanda's desires, rather than spam or other advertising whose targeting is specified by a merchant. Wanda may express a desire or preference 241 to receive information for specific brands or types of products, such as ceramic tile. Match software 161, FIG. 1, may use this information to select which products P will be sent to Wanda's promotion space as files, resource locators (e.g., URLs), or other data for her inspection. When Wanda logs in, her initial page may contain a notice that a new product has arrived. She might then click on an Offers tab to display a page with new products, and possibly previous offers as well. This page may contain links to other pages for displaying descriptions, coupons that she may print, or other material. New products may be located in library 150 or in some other temporary storage until Wanda accesses them.

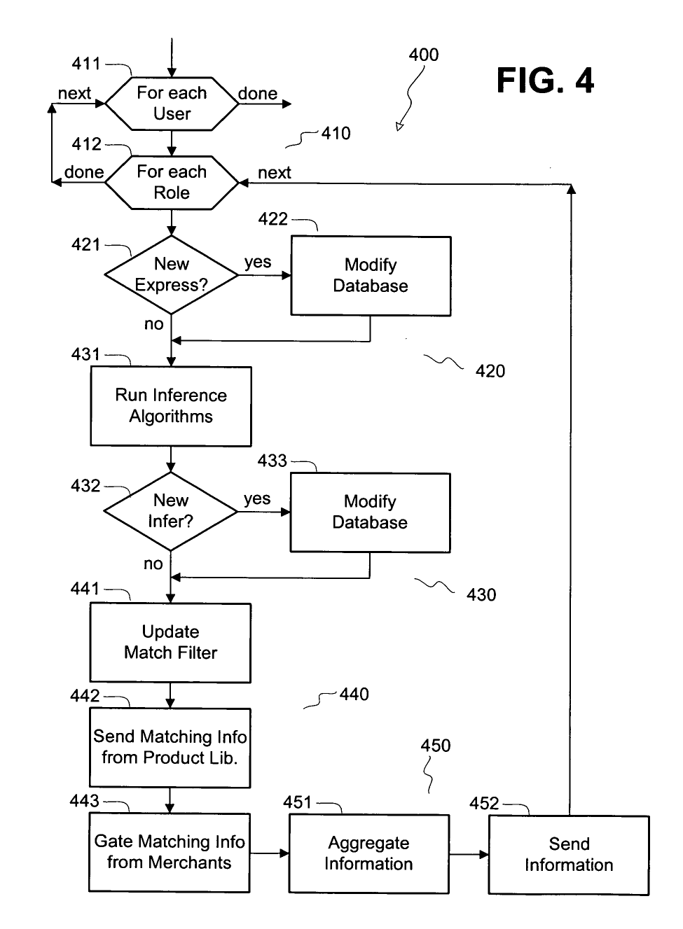

Another facility 242 receives information from inference software 180, FIG. 1, as to items that Wanda might wish to receive, based upon other activities in her space 130. For example, queries for ceramic tile products may prompt facility 242 to pull products from merchants that lay ceramic tile, as described in more detail in FIG. 4. Information for inferring desires may come from records of product and other searches that Wanda requests from a search component 243. Records of this type are stored in Wanda's area of user database 160.

Entree to promotional space 240 occurs through a merchants' interface 244 set up by the sponsor. Merchants' area 250 of website 100 communicates to the interfaces 244 of users via a doorway 251. Material from affinity merchants 103 flows through interface 244 to Wanda's promotion space 240 only in response to matches to Wanda's expressed and inferred desires.

Information may flow in both directions through interface 244 and doorway 251. For example, Wanda may employ doorway 251 in a collaborative manner with a merchant's representative or to allow Wanda to request additional information directly from a merchant. A mechanism such as a threaded dialog may implement this feature. (Some embodiments may permit threaded dialogs or blogs among multiple users as well.) Further, the sponsor may permit merchants—or certain merchants, perhaps authorized on a per-user basis—to access specified items in or connected with Wanda's personal webspace. For example, real-estate agents may have access to Wanda's searches for residences she is considering purchasing. This feature is an incentive for merchants to become affiliated with website 100, although the extent of access must be balanced against users' privacy interests. User agreements may disclose access authorizations granted by the sponsor. Merchants normally can access all products, although they can change only their own. Area 250 may provide other facilities for merchants' use, such as a bulletin board 253.

Other channels may be made available for affinity merchants to communicate with some or all users. However, it is contemplated at present that e-mail to users' website accounts 211, regular mail, telephone, or other forms of communication should be an opt-in choice by individual users, available only when users request specific follow-ups via those modes, or employed to notify users that their personal webspaces contain new material. A significant objective of webspace 100 is to establish dynamic website communication as a new communication/delivery channel different from conventional mail, e-mail, and telephone, which are often spam infested, and which do not offer the flexibility, features, and data-collection capabilities of a sponsored website.

Spaces 210-240 or others are virtual entities. The functions and data that make up a space may be implemented in a number of ways that are or may become known to website designers. Examples include website pages or portions, components that reside on pages, or database data accessible to one or more pages or components. For instance, Wanda's saved searches may be considered part of her personal space and thus viewable on her saved-search page; however, may also be viewable by her agent in his client-management function, and may be accessed by aggregator 170 for calculating marketability or other measurements.

Navigation devices such as menu bars may be set dynamically; certain shared spaces may simply be not present on the menu bars of users who are disallowed from navigating to those pages. Virtually nothing on any page need be static; pages may be considered to be entities for displaying appropriate information and for granting access to appropriate functions. Wanda's webspace, including functions she may perform, others' spaces that she may share, information she may view, or how she may use it (e.g., edit, comment, create new data) may be configured anew from databases or profiles every time Wanda log on to her webspace 200, according to her role(s).

Merchants' area 250 may include a number of features for the benefit of affinity merchants 103. Interface 252 permits merchants to enter, change, and withdraw products P in product library 151. The sponsor may communicate with merchants through this area, either directly or via a facility such as bulletin board 253. Area 250 may contain other information for merchants, such as rules, standards, guidelines, product categories, or formats.

Doorway 251 permits products—especially promotions—to be delivered to Wanda in a timely manner. Whenever an affinity merchant 103 delivers a promotion to website 100, that product reaches Wanda's promotion space immediately. Match software 161 sends products already stored in library 150 directly to Wanda's space 240 as soon as she makes her desires known through facilities 241-243 or other channels. Merchants may distribute products, promotions, or other material on a real-time basis to users. Match software 161 may determine which users are to receive the material, and distribute it dynamically, as it is received. This permits, for example, time-sensitive offers in an effective manner. Facility 242 may present inferred desires or preferences almost instantaneously from inference engine 180. Merchants may log in to area 250 through a special URL, such as Deliveries.Bizcorp.com in FIG. 2, with their names and passwords or other security.

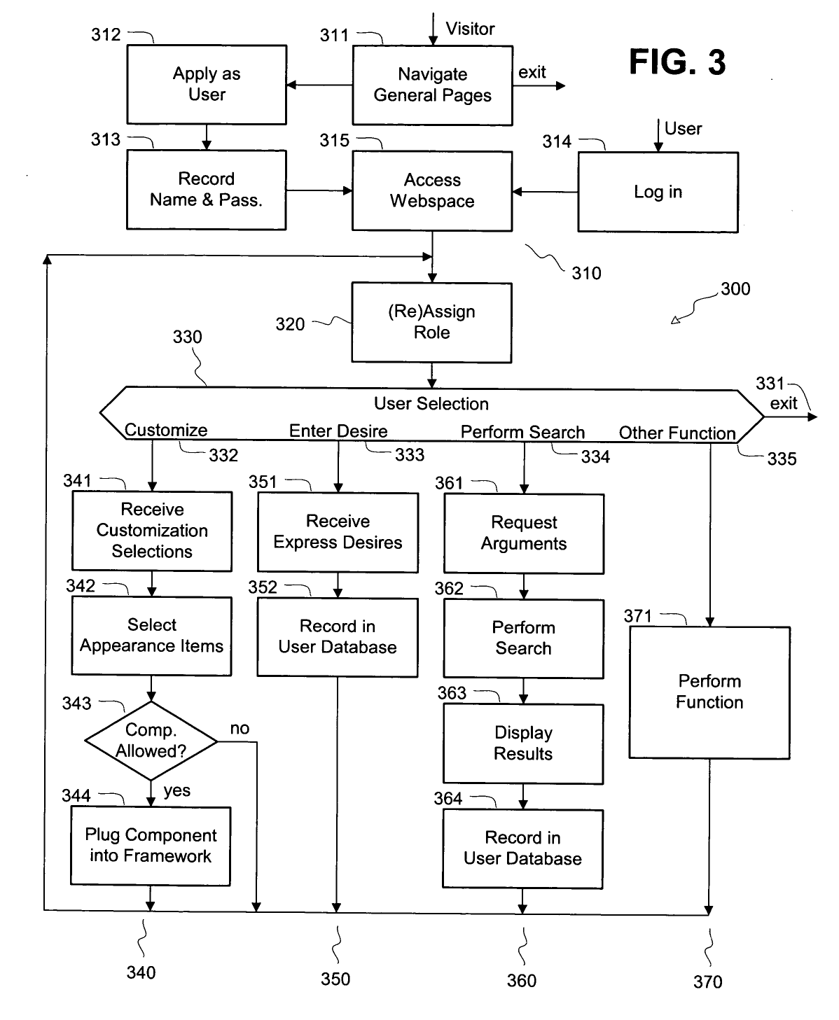

FIG. 3 illustrates an example of a method 300 for performing certain user functions. Operations 310 perform preliminary procedures at an entry page of general pages 110, FIGS. 1 and 2. Visitors to website 100 may navigate through the general pages at will, at operation 311, and may exit as they would from any other website. Visitors may apply to become users at block 312. Application involves providing certain information, such as a valid e-mail address (which can be checked by mechanisms such as e-mailing a notice and requiring a click on a link in the e-mail). In particular, the application may request information needed to qualify for specific roles, such as whether their primary interest is in buying, selling, or remodeling a property. Alternatively, others may apply for them, perhaps providing qualifying information for a role. For example, real-estate agencies may sign their clients up in buyer, seller, or client roles, as a benefit of their own services. Block 313 records usernames and passwords or other user-specific information. Current users may log in directly at block 314. Block 315 accesses the users' own personal webspaces.

Block 320 assigns roles to new users from information supplied by the users or by others for them. Some example roles include:
Prospective buyer: One who is contemplating purchasing a real-estate parcel, but has not yet taken any formal steps to initiate a transaction. This and other roles may be subdivided into types such as residences, commercial, and industrial properties. They may also be differentiated by desired transactions, such as sales and leases. This example will employ the example of a purchaser of a personal residence; others operate similarly.
Buyer: One who is in the process of purchasing a parcel of real estate. This role may include, for example, users who are clients of a real-estate broker affiliated with the sponsored website or those who have signed a contract for a specific parcel. This role may be divided into types for each of these criteria, or for others.
Owner: One who has completed a real-estate transaction. Subclasses may be established for time since last property purchase, such as less than one year, one to five years, etc.
Prospective seller: One who is contemplating placing a real-estate parcel on the market, but has not yet taken any formal steps to initiate a transaction.
Seller: One who is presently engaged in selling (or leasing, renting, etc.) a real-estate parcel. As in the case for buyers, different requirements may be imposed, or different types offered.
Client: An active client of a real-estate agent or broker affiliated with the website, such as a person who has signed an agency agreement.
   Block 320 may also reassign roles to existing users. Certain roles may be assigned or reassigned at the users' behest, such as through an amended application at block 312 or 341. The website sponsor or system administrator may change (modify, add, or delete) users' roles in response to new information in user database 160, FIG. 1. For example, a “prospective buyer” may be upgraded to a “buyer” when an affiliated Realtor® or other agent informs website 100 that this user has signed a purchase agreement. Role reassignments may occur manually, or automatically via rules on the website. For example, website 100 may establish sub-roles of owners, and may change users' sub-roles when one year has passed since the users' most recent home purchase, five years after purchase, etc. Roles are not hierarchical in this illustrative embodiment, but the same user may be assigned to multiple roles, such as “seller” and “client.” Users are authorized to any components or other privileges that accrue to any of their roles.

Block 330 represents users' choices within any subspaces of their own personal webspaces. Such choices may be made from menus or other interface devices presented by framework 131 within the webspaces. Only a few choices are shown, for simplicity. Exit 331 may transfer among subspaces such as 210-240, FIG. 2, or may exit the webspaces altogether. All choices may be available from all subspaces, or some choices may be available only in certain subspaces.

Choice 332, which may be available generally or only in, say, personal space 240, invokes a customization or configuration operation 340; these terms are synonymous herein. Operation 341 may receive user selections of features, skins, and other items from a menu or similar interface. Skins may modify the appearance of personal webspaces and individual subspaces in ways similar to those employed in application programs such as media players. Other appearance items, such as visual arrangement of items, may also be selected. The sponsor may give users varying amounts of control in terms of visual appearance, component arrangement, or navigation. More control increases complexity, which may prompt the sponsor limit choices for that reason. Block 341 may also select features and other facilities to be implemented in webspaces, or in particular subspaces. Users' selections may be stored as profiles in their areas of database 160.

Among the choices at block 341, users may be permitted to name other persons, such as family members, as invitees to some or all of their personal webspaces 130. Invitees may be users or non-users, and may be given their own names and passwords. They are limited to the capabilities allowed to their associated users' roles, and the users (or the sponsor) may restrict them further. For example, a user may allow family members access only to a family subspace 220, FIG. 2, to view the user's new house, to leave comments in the user's blog, or to share a promotion, if the issuing merchant has designated it as shareable. If the invitees are other users of website 100, users may elect to share part or all of their webspace with them, so that these other users may have access to designated facilities, such as saved searches or favorites in the grantees' personal webspaces. Users' ability to customize their webspaces increases the attractiveness of website 100, and is an incentive for them to visit it frequently. However, many of the benefits of the website are achievable without some or all of the customization capabilities.

Block 342 implements the skins and other appearance items selected in block 341. Block 343 asks whether components selected in block 341 are permitted to the roles of the requesting users. That is, components—and other items as well—may be made roles-aware. Generally, customization menus will display to the users for their selection only those choices permitted to their roles. If so, block 344 plugs the corresponding components into the users' framework. After customization has completed, control returns to block 330. Block 320 is included in this loop to indicate that a role may be changed at any time.

Choice 333 at block 330 indicates that users wish to enter or change their expressed desires. Block 351 of routine 350 presents dialog boxes or other interfaces to enter one or more such desires for products. Users may enter evoked sets of products or types. (When prospective buyers consider purchasing a class of goods or services—such as automobiles—they do not consider all possible models or brands equally. Instead, they tend to carry around a small “evoked set” of them in their heads.) Block 352 formats the users' desires and transmits them to corresponding users' areas in database 160, FIG. 1, for storage. For example, evoked sets for real-estate properties may be stored in a list format having summary views with thumbnail pictures and brief descriptions; detail views may contain or refer to larger pictures and fuller descriptions.

One important function that users may select is a search, at choice 334. Search routine 360 may represent one or more types of search, invokable at one or more of the spaces within personal webspace 130. Block 361 requests search arguments or parameters from users in a dialog box or similar interface device. This interface may reformat user queries, or possibly obtain other information from requesting users. Block 362 performs the search. This operation may be performed internally within website 100, among certain parties selected by the sponsor (such as the affinity merchants), or externally, possibly employing an unrelated outside search facility. Block 363 displays search results to users within their personal webspaces. In addition, block 364 may enter certain information into the users' database areas. For example, block 364 may record search arguments, search results, or times, frequencies, or duration of search activity. If desired, non-user visitors may also be allowed to search real-estate listings; the properties they view may also be useful in determining market demand.

Choice 335 represents invocation of other functions 370. Block 371 performs these other functions and returns control for further choices. Such other function may involve, for example, sending/receiving mail, importing pictures to family album 221, FIG. 2, or reading newsfeeds or market reports. Although many such features may be ancillary to the major purpose of a sponsored website 100, they offer incentives for users to visit their spaces frequently, and even to invite others to become users themselves.

FIG. 4 shows a method 400 for matching user desires to product offerings in a “pull” marketing technique. Method 400 may be implemented as matcher software 161, FIG. 1. A significant aspect is that it appears to execute in near real time from the perspective of users 102 and merchants 103. For example, new product offerings should find their way to matching users' personal webspaces within a few seconds to a few minutes.

Iterative elements 410 control overall execution. The method may execute continuously within sponsored website 100, or it may be triggered by specific events such as newly entered user desires or new product offerings (not shown). Block 411 iterates the method for each user who has a promotion space 240, FIG. 2. Generally, all users will have such a space. Block 412 iterates the method for each role of the current user, if users are allowed to have multiple roles.

Routine 420 enters desires for products that the current user expressly requests. Block 421 may detect that block 351, FIG. 3 has received a new, changed, or deleted request for a specific product, a type of product, or some other category of offering. Block 422 then modifies the database area corresponding to the current user with the new information. The information may be formatted (not shown) to facilitate matching and aggregation.

Routine 430 runs inference engine 180, FIG. 1, at block 431 to generate any new (or changed or deleted) desires that may be inferred from the current user's express desires. If block 432 detects any modification to this user's set of inferred desires from database 160, block 433 stores them in the user's database area. Again, these may be formatted if necessary. Expressed and inferred desires may be stored together in the user's database area, or they may be segregated.

Routine 440 updates the current user's promotion area from the new expressed and inferred desires. Block 441 modifies a match filter or template that is specific to the current user. Block 442 selects product information from product library 150, FIG. 1 that matches the filter, and send it to that user's promotion space 240, FIG. 2. Products already in the library will normally be delivered to a user's personal webspaces within five seconds after that user meets the applicable criteria to receive them. Block 443 employs filter 441 (or a separate similar filter) to gate products to the promotion space substantially in real time as those products may subsequently arrive from affinity merchants 103. Real time in this context may range from less than one second to five minutes or so.

Routine 450 implements aggregator 170, FIG. 1. Block 451 may execute whenever routine 400 iterates, or it may run intermittently. The aggregator may analyze data from real-estate agents to determine, for example, how many residences are presently on the market within given types or price ranges, or what the daily market activity is. It may extract user data from database 160 to analyze trends in specific types of home-improvement products such as siding types or floor coverings. Aggregator 451 may distill data from users, from merchants, or from outside sources, alone or in combination with each other. Block 452 may make this data available to users, to affinity merchants, or to others, with or without charging a fee for its use. Just as bar coding gave retailers new leverage over manufacturers, aggregated real-estate and related product information may change the balance of power in this market.

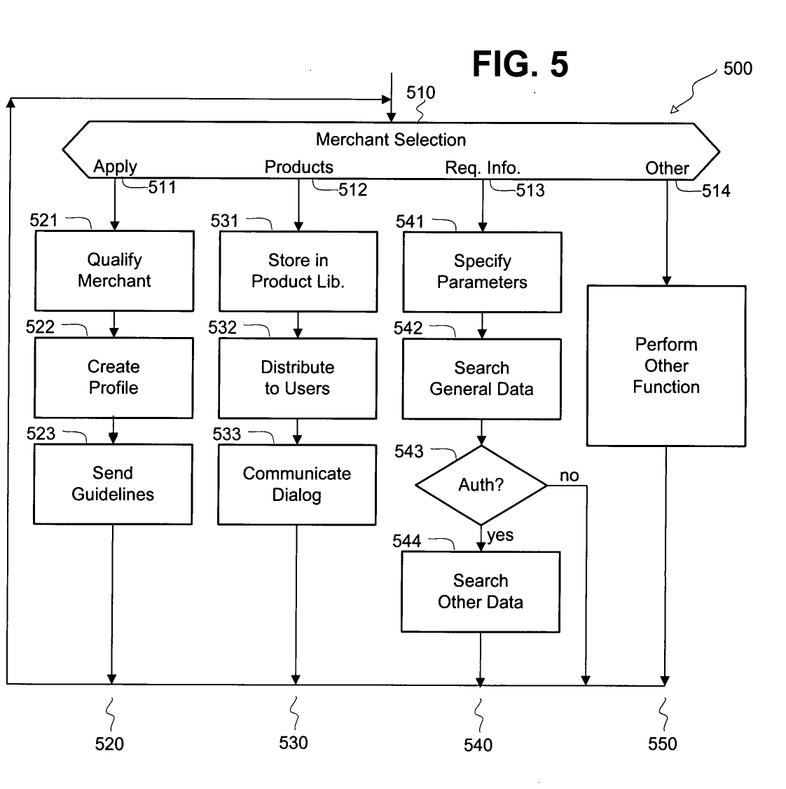

FIG. 5 shows an example of a method 500 for performing merchant functions in connection with a sponsored website. The method runs autonomously from other methods, and may iterate continuously as shown, or may execute at certain times or in response to designated events. Block 510 requests an action. Four choices 511-514 are shown, but many others are available to some or all merchants.

Routine 520 is invoked when choice 511 invokes routine 520 to qualify a new affinity merchant. Block 521 detects that a merchant has accessed sponsored website 100, FIG. 1, for the purpose of applying for affinity status. Block 521 qualifies the merchant by requesting information as to the merchant and its proposed products. The sponsor's representatives may also adduce outside information such as credit ratings and reputation in the market in order to assure an expected level of quality, reliability, and other factors. If the merchant qualifies, block 522 enters a profile into product library 150 or other storage. Merchants may be qualified in different classes or categories according to criteria established by the sponsor. Merchants may be given authorizations contingent upon their categories. For example, a local home-products merchant or lumberyard may be authorized only to users located within a certain area surrounding its geographic location. Certain merchants may be given—or purchase—exclusive or other special status in certain areas or for certain product lines or brands. Categories or authorizations may also be predicated upon various amounts of access merchants may obtain to users' personal webspaces, or which users they may access. For example, a real-estate agent in one MLS area might be denied access to MLSs in other areas.

Block 523 may send the merchant guidelines and other information concerning its dealings or interface mechanics with website 100. For example, the sponsor may send templates to insure consistent formats for product information. The sponsor may also send lists of standard categories or keywords for products, so that inference engine 180 may relate them properly to users' expressed desires.

Selection 512 activates routine 530 when a merchant wishes to send a new (including changed, or deleted) product, such as a description file, a promotion, a brochure, or other information. Block 531 may store the new product in product library 150, along with its accompanying data, such as IDs of participating merchants, keywords, bar-code data, or a date range for special offers. Block 532 may gate products to the appropriate users in substantially real time via operation 443 of method 400. Block 533 may carry on a threaded dialog between a merchant and one or more users via interface 244.

A merchant may invoke choice 513 to request information from website 100 via routine 540. Block 541 receives parameters for the search. Some requested information may be available on the website generally, such as aggregated data, trend and market data, listings, or histories. Block 542 obtains and returns this type of data. Other requested information may concern individual users, such as saved searches, favorites, product purchases, or properties currently offered for sale. Block 543 determines whether the requestor is authorized to receive the data specified in block 541. If so, block 544 obtains this data and returns it to the requestor. The sponsor may permit merchants to share certain portions of users' personal webspaces 200. The sponsor may restrict this ability to certain merchants and to certain users, on any basis. Real-estate agents may have access to users in client roles of their agencies, to view saved searches or evoked sets, for example. Sharing permissions may be quite complex, if desired. For example a user may allow a friend to see and comment on his saved searches, but the agent, although allowed to user the user's search itself, may be denied access to the friend's comments on that search.

Agencies and client users may collaborate in threaded discussions, which either may initiate. Restrictions may be enforced by filters in communications facility 190, FIG. 1.

Other choices 514 may invoke other routines or functions 550.

### Tools for Real-Estate Market Analysis

System similar to those illustrated in connection with FIGS. 1-5 collect large amounts of information concerning real estate parcels and people who purchase them. Aggregating and manipulating this data, as in unit 170, FIG. 1, offer opportunities to enhance the operation of the real-estate market by means of predictive estimates. Adaptive methods may generate such estimates from information collected at a website such as 100.

Real-estate professionals would prefer to base their actions upon data from prospective purchasers (buyers, lessees, etc.) who have a real interest in near-term purchases (or leases, etc.), and not upon those who are merely curious. However, it has been difficult to separate the serious real-estate shoppers from casual tire-kickers. The invention also offers a tool for generating an adaptive propensity-to-buy index (PBI) or ranking to gauge the likelihood that particular prospects will engage upon a real-estate transaction, based upon contemporary data collected about them.

FIG. 6 illustrates the computer-based method 600 for generating a PBI for a particular user of website 100. Operation 610 receives a request for a PBI for a specific subject—an individual or groups of individuals—by name or other defining characteristics. Block 611 determines whether the requester is authorized to obtain this index. A person such as the sponsor of website 100 may establish rules as to which users, merchants, or other persons (or organizations) are permitted to obtain an index, and may restrict them as to subjects for whom they may obtain an index. Privacy laws and policies may influence some of these rules.

Block 620 reads data that the subject himself may have saved in user database 160 or elsewhere. Such information may include saved search parameters, stored express or inferred desires as to properties or products, or evoked sets (sometimes called consideration sets or awareness sets).

Block 630 reads activity data concerning the individual subject, which may be gleaned from a continuously or periodically running monitor 631. This information may include the subject's log-in activity such as frequency or time of last website use, search activity such as frequency or time of last search, search parameters entered, questions asked, products or properties viewed, promotions accepted, or price and date of sales of property for the subject. The monitor may obtain data stored in user database 160, from administrative software (not shown) for website 100, or from other sources. For example, data concerning previous purchases may be obtained from merchants 103, from real-estate agents, or even from government records such as new deed recordations. Sources may provide such data manually to website 100, or automatically.

Block 640 determines which products the subject has a propensity to buy. If, for example, the subject has a role indicating he may become a home buyer, block 640 may determine differences between properties in his profile (saved searches, evoked sets, etc.) and properties in product library 150, and generate numerical factors indicating goodness of fit for each of these properties. Factors can be generated for other products in the subject's profile on a similar basis, and may also include activities such as his queries to merchants, accesses of how-to information on certain topics, or visits to other websites. Dates and frequencies of these activities may weight the generated factors. In addition to considering products expressly saved in searches (expressed desires), PBIs may be extended to products whose relevance to the subject may be inferred by block 180, FIG. 1. On the other hand, PBIs may be narrowed by the system based upon the requester; for example, a request by a user having an agent's role may be limited to calculating PBIs for residences.

Block 650 calculates the values of PBIs for the requested subject for the products found in block 640. A range of algorithms is possible for this calculation, and different algorithms may pertain to different types of products. Algorithms may be expressed as equations, as sets of rules, as decision trees, or in other forms. Data considered may include the subject's assigned roles, measures of specificity in the subject's saved searches, numbers of products in evoked sets or how closely they are clustered, log-in frequencies or dates, and use of or queries about new products matching his profile. Inputs to algorithms for purchasing real-estate properties may include whether the subject is also a seller, the current market index (see FIG. 7) of the property he has on sale, acceptance of promotions from mortgage lenders or other related merchants. Real-estate algorithms may calculate the subject's PBI values for different price ranges of properties, different locations, different number of bedrooms, and so on. PBI values may represent probabilities that the subject will purchase the product or as an estimated time-to-purchase. The latter form is especially appropriate when the products are real-estate parcels. PBIs may also be calculated as functions of time; e.g., probabilities of purchase are 30%, 70%, 40%, 10% at monthly intervals from the time of calculation, or time-of-purchase PBIs may be recalculated at selected intervals after the request. Because of the large amounts and types of information stored on website 100, requested PBI calculations may typically be performed in less than five minutes, and often in less than thirty seconds or even five seconds.

Block 651 may run continuously or periodically, independently of the other operations, to receive subsequent actions of the subject, via monitor 631 or other inputs, to compare the subject's actual activities with an internal prediction based upon the generated PBI, and to update the algorithm employed by block 650 to calculate PBIs. For example, history file 152 knows when real-estate properties are sold; block 651 may verify PBIs at the expiration of time-to-purchase PBIs, or at the end of predetermined intervals for probability values. Similar techniques may be employed for other products. For example, the redemption of bar-coded promotion coupons may be tracked through history file 152. A simple way to alter the PBI algorithm is to modify coefficients in a formula. However, it is also possible to perform statistical analyses of PBI predictions, then alter even the entire form of the algorithm through mathematical curve-fitting techniques, perhaps using aggregated data from block 170, FIG. 1.

Block 601 may return control to iterate blocks 620-650. That is, a requested PBI may be updated continually until cancelled by the requester, or until some other termination, such as the expiration of a set time period. That is, block 650 may dynamically recalculate or update the PBI continuously, periodically, or upon the occurrence of some event.

Real-estate professionals also wish to estimate the marketability of particular parcels of real estate. Conventionally, they base the marketability of properties upon historical analyses of market prices. This approach has two shortcomings. First, being based upon historical prices for comparable properties, it may lose accuracy in dynamic markets where demand and prices change rapidly. This is true of many local real-estate markets. Second, being based upon recent sales of comparable properties, it may lack statistical significance. The invention thus offers a current-marketability index (CMI) for measuring the relationship between market demand and inventory based upon large volumes of contemporaneous data.

FIG. 7 shows an example of a computer-based method 700 for generating CMIs. Normally, website 100, FIG. 1, may offer this facility to all users as a valuable attraction of the site. However, it may be desirable in some cases to restrict it to certain roles or other categories of website users.

Block 710 receives requests for CMI values for real-estate parcels. The requests may specify properties already on the market from, say, listings 151 on website 100. For example, an agent may obtain a CMI on a client's residence already on the market, in order to determine where it ranks with respect to other homes on the market, possibly to recommend a change in the asking price for changing market conditions. A requestor may alternatively enter characteristics of a property not on the website, for example location or price range, to determine the demand for a prospective seller's own residence at a particular price point in the current market, before actually putting it up for sale.

Block 720 reads data concerning properties that are currently on the market that meet the requested characteristics as to, say, house size, numbers of bedrooms and baths, neighborhood, or other criteria. If desired, recently-sold properties may be included as well, to provide an actual-sales input to the algorithm. Such data may come from one or more property listings on the website, listings maintained by real-estate agencies affiliated with the website as affinity merchants, or other public listings, on-line or off-line, using automatically or manually entered data.

Block 730 may invoke a routine such as 600, FIG. 6, to determine current PBI values for users who are doing business with an agent (e.g., in “client” roles).

Opening the field to other users, however may be useful in determining which leads to pursue. Rather than relying only on historical data as to who has purchased comparable properties, block 730 allows dynamic consideration of who is currently likely to buy certain properties. Alternatively, block 730 may employ internally derived criteria. For instance, in the example CMI calculation below, valid shoppers may be defined as website users in certain roles who have visited their personal webspacesl30 within the previous five days.

Block 740 calculates a CMI value according to the request. In this example, its value may be defined as M=D/I, where inventory I represents the number of active listings that match the queried property, and demand D=mS_{V}+nS_{VF}. The constants m and n are settable parameters between 0 and 1, and may be initially set to ⅓ and ⅔, respectively. Sᵥ represents the number of valid shoppers (as determined by their PBI values) with at least one saved search on website 100 that matches the requested property. The criterion for a match is that a user search would find the subject property. However, matching parameters may be weighted. For example, price and location may be weighted more heavily than number of bathrooms in determining the closeness of matches to the requested property. S_{VF} may be calculated using PBIs, or by other techniques. As a simple example, it may represent the number of valid shoppers having one or more favorites that match the requested property. CMIs may also be calibrated to estimated time-to-sale for the properties, if desired.

A number of characteristics that may define a matching property. Some examples pertaining to residences may include price range, square footage range, number of beds or baths, construction style category, location (such as a multiple listing service area, a city, etc.), year built, or number of garage stalls.

Instead of executing in response to requests, block 740 may run autonomously, and may calculate CMIs for all properties in listings 151 continually.

Block 741 may run continually, independently of other operations, to update the calculation algorithm of block 740. For example, block 741 may receive sales data for from agents or from history 152 for comparing its own estimates of time on the market to actual time required to sell a property. These data may modify the values of m and n above, or other parameters in the CMI calculation. Statistical curve-fitting techniques may also be employed. This and other corrective inputs may render the CMI a more accurate quantitative predictor, more than merely a comparative or qualitative measure. Block 741 may also track actual purchases in order to translate CMI M values to estimated time-to-sale values.

Block 750 displays one or more CMI values to the requestor. For example, a requestor may obtain a graph of estimated days to sale for the same property at multiple price points, in order to achieve a quick sale or a maximum price.

Block 701 controls iteration, and may represent several operations at various points in method 700. The requestor may ask that a CMI be updated for a period of time or other criteria. In this case control returns to block 720 to recalculate the CMI continuously or periodically. The requestor may wish to add other requests having different characteristics, such as different price points. In this event, control returns to block 710. An exit terminates the request.

Block 760 may generate data for producing trend data for a queried subject property. The requester may specify an interval for trend results. Unlike other MLS systems, website 100 maintains—or has access to—a dynamically updated quickly accessible transaction history database 152 showing dates of events such as price changes, status changes, contingencies, when placed on the market, etc., for properties in listings 151. Block 760 may then calculate trends such as:
Absorption rate: The ratio of sold listings to new listings that match a subject property.
Price: The price of newly listed properties that match the subject property's parameters except for price.
Days on market: The average number of days of pended or closed properties that match the subject property.
Inventory: The number of active properties that match the subject property.

Block 750 may tabulate or graph these factors as functions of time.

Merchants may calculate these trends externally to website, or may calculate trends of their own devising, by extracting data offered by history database 152. For example, Realtor® users may specify market segments for which they wish to receive market performance data according to parameters such as price, location, or residence attributes—age, location, size, bedrooms, etc. They may then plot their own graphs for selected ranges and frequencies of this data to represent initial or final listing prices, sale price, time on market, numbers of closed, pending, or active properties, absorption rates, etc. The CMI may be combined or utilize the market performance data.

The description of method 700 has been particularized to CMIs for real-estate properties, for which it is especially valuable. However, the same or similar methods may generate CMIs for other products as well, especially those in limited supply. For example, block 720 may read product characteristics of other products P from library 150, FIG. 1. Inventory I may be calculated on bases such as numbers of items manufactured, shipped, or on-hand per month, for example. Data tracking for methods 600 or 700 may utilize mechanisms similar to those that so-called “adware” programs employ; however, website 100 can track many more data items, respects the users' privacy, and does not invade their personal computers.

### CONCLUSION

The foregoing description and the drawing illustrate specific aspects and embodiments of the invention sufficiently to enable those skilled in the art to practice it. Alternative embodiments may incorporate structural, logical, electrical, process, and other changes. Functions said to be embodied in software may be wholly or partially implemented in equivalent hardware. Examples merely typify possible variations, and are not limiting. Items in lists may be selected individually without reference to other listed items, or may be selected in any combination. “Or” is intended in a non-exclusive sense, as either “or” or “and.” between each item. Lists are not exhaustive, unless so stated. Individual components and functions are optional unless explicitly required, and the sequence of operations in methods may vary, may be performed concurrently, or may occur partly or wholly in other methods or locations. Portions and features of some embodiments may be included in or substituted for those of others. The Abstract is furnished only as a guide for subject-matter searching, and not for claim interpretation. The scope of the invention encompasses the full ambit of the claims and all available equivalents.

We claim as our invention:

1. A method comprising:
providing a sponsored website for products connected with real estate;
defining a set of roles based upon different relationships between website users and the products;
assigning the roles to the users;
storing a library of components having respective role designations;
constructing personal webspaces for the users from selected ones of only those components having role designations included in the users' assigned roles;
storing user activities involving predetermined ones of the components on the website in a user database;
receiving information concerning the products from multiple merchants;
matching the products to the users based upon the users' activities;
distributing the information concerning respective ones of the products only to those users whose activities match the respective products.

2. The method of claim 1 where at least some of the products are real-estate properties.

3. The method of claim 2 where the roles include buyers and sellers of the properties, and agents for the properties.

4. The method of claim 3 where the roles include client of an agent.

5. The method of claim 3 where the roles include owner of a property.

6. The method of claim 2 where certain of the users are assigned multiple roles.

7. The method of claim 1 where users having a certain assigned role assign other users to at least one other role.

8. The method of claim 7 where a user having an agent role assigns other users to client roles.

9. The method of claim 1 where the product library includes a listing of real-estate properties.

10. The method of claim 9 further including dynamically maintaining a history database of events concerning the properties.

11. The method of claim 10 further comprising:
aggregating data from the history database
calculating a measurement concerning one of the properties from the aggregated data.

12. The method of claim 1 further comprising:
accessing certain activities of one of the user;
calculating a propensity of the one user to buy at least one of the products in response to the accessed activities.

13. The method of claim 12 where the activities are taken from the group of expressed desires or saved searches.

14. The method of claim 13 further comprising deriving inferred desires from the expressed desires or the saved searches.

15. The method of claim 1 where certain users have the ability to access portions of the webspaces of other users.

16. The method of claim 15 where the certain users grant express permission to the other users.

17. The method of claim 15 where a sponsor of the website grants permission to the certain users, and defines the other users.

18. The method of claim 15 where the portions include predetermined activities of the other users.

19. The method of claim 1 further comprising establishing dialogs internal to the website among users.

20. The method of claim 19 where certain of the users are merchants who supply the products.

21. The method of claim 1 where constructing the webspaces includes selection by the users of optional ones of the components having role designations

22. The method of claim 21 where customizing includes selecting appearance items for the websites.

23. The method of claim 1 where the components include e-mail and newsfeeds.

24. Apparatus including at least one server coupled to a wide-area public network for implementing a website comprising:
a library of products connected with real estate;
a library of components interoperable with a framework for providing functions on the website, each of the components being associated with one or more roles;
a plurality of personal webspaces for users having individually assigned ones of the roles;
a customizer for constructing the webspaces so as to include one or more components selected from only those components having roles corresponding to the roles of their own users;
a user database for storing user activities on their webspaces;
a matcher for matching the products to users in response to activities of the users;
a communications channel for distributing information concerning the products to various ones of the users in response to the matcher.

25. The apparatus of claim 24 where the communications channel includes a facility for internal dialogs among multiple ones of the users.

26. The apparatus of claim 25 where the multiple ones include merchants who supply the products.

27. The apparatus of claim 24 where the communications channel includes a facility for certain users to share portions of the webspaces of other users.

28. The apparatus of claim 24 where the product library includes a listing of real-estate properties.

29. The apparatus of claim 28 further including a dynamically updated a history database of events concerning the properties.

30. The apparatus of claim 24 where the user database includes activities of the users.

31. The apparatus of claim 30 further including an inference engine for producing inferred desires of the users from their activities.

32. A method of measuring the propensity of a subject to purchase, comprising:
maintaining a library of products connected with real estate on a website;
maintaining a database of activities of multiple users of the website, the users including the subject;
accessing activities of the user with respect to the products;
calculating a propensity-to-buy (PBI) value according to an algorithm including the activities;

33. The method of claim 32 further comprising:
selecting certain of the products based upon the subject's activities with respect to the certain products;
calculating a PBI value for each of the products.

34. The method of claim 32 where the algorithm includes measurements of visits to the website.

35. The method of claim 32 further comprising updating the algorithm based upon activities of the subject subsequent to calculation of the PBI value.

36. A method for measuring the marketability of a queried product connected with real estate, comprising:
maintaining a library of currently available products for purchase;
maintaining dynamically updated history database of events concerning the currently available products;
maintaining a database including activities of prospective buyers of the available products;
calculating a current market index (CMI) value for the queried product in response to the currently available products and activities of the prospective buyers.

37. The method of claim 36 where:
the queried product is a real-estate property.
the library includes a listing of currently available real-estate properties.

38. The method of claim 36 where the activities include searches in the library by the prospective buyers.

39. The method of claim 36 where the queried product is included in the library of currently available products, and further comprising:
accessing the history database for events concerning the queried product subsequent to calculating the CMI value;
updating the algorithm in response to events in the history database concerning the queried product.
